(19) United States
(12) Patent Application Publication
(10) Pub. No.: US 2020/0172291 A1
(43) Pub. Date: Jun. 4, 2020

(54) SYSTEMS AND METHODS FOR NESTED CARTRIDGE

(71) Applicant: GRD Ventures, Lisle, IL (US)

(72) Inventors: Joseph Mogor, Wheaton, IL (US); Richard Simon, Hinsdale, IL (US); Jonathon Flowers, Chicago, IL (US); Randal Briesath, Aurora, IL (US)

(21) Appl. No.: 16/702,038

(22) Filed: Dec. 3, 2019

Related U.S. Application Data
(60) Provisional application No. 62/775,147, filed on Dec. 4, 2018.

(51) Int. Cl. B65D 21/02; B65B 51/22; B65D 77/20; B29C 65/00; B29C 65/08

(52) U.S. Cl. CPC B65D 21/0233; B65B 51/225; B29C 65/08; B29C 66/53461; B65D 77/2024

(57) ABSTRACT

Disclosed are systems and methods of a nested cartridge system configured to store and/or dispense particulate food products, such as spices and herbs. The system houses one or more cartridge assemblies, which provide a secure and sanitary container for the food product. When stored in the nested container, the cartridge assemblies are oriented at an angle, and organized to be easily identified and grasped. The system includes a compatible measuring tool, which provides multiple measurement units for convenience.

### CROSS REFERENCE TO RELATED APPLICATIONS

This application is a Non-Provisional patent application of U.S. Provisional Patent Application No. 62/775,147 entitled “SYSTEMS AND METHODS FOR NESTED CARTRIDGE” filed Dec. 4, 2018, which is herein incorporated by reference in its entirety.

### BACKGROUND

Storage systems for food products are used to maintain freshness and convenience. Many food storage systems are not suited for use in different locations or placement in a variety of configurations, nor are they capable of providing easy identification of or access to the contents. As a result, a user unable to verify the contents may inadvertently select the wrong product, and/or may run out of a particular item without being able to identify the contents of a particular empty container. These problems are compounded when a location is not well suited for the storage system use.

Furthermore, some food storage containers are used for food items which are measured for use, such as spices and baking ingredients. In these instances, measurement tools are needed once the desired product is selected. Without a purpose built measuring tool, erroneous measurements can be made when the proper tool is not available. Thus, the need exists for a storage and dispensing system that provides a solution to these and other problems.

### SUMMARY

Certain embodiments of the present technology relate to a nested cartridge system configured to store and/or dispense various products. In particular examples, the system is used to store spices in secure and sanitary cartridge assemblies, organized in a tilted and nested container, while providing a useful, system compatible measuring tool.

### BRIEF DESCRIPTION OF SEVERAL VIEWS OF THE DRAWINGS

FIG. 1 illustrates a perspective view of a nested cartridge system, according to certain inventive techniques.

FIG. 2 illustrates an exploded perspective view of a nested cartridge system, according to certain inventive techniques.

FIG. 3 illustrates an exploded perspective view of a single cartridge assembly, according to certain inventive techniques.

FIG. 4 illustrates a perspective view of the cartridge assembly illustrated in FIG. 3 with a measuring tool, according to certain inventive techniques.

FIG. 4A illustrates a perspective view of another single cartridge assembly, according to certain inventive techniques.

FIG. 5 illustrates an alternative perspective view of a nested cartridge system and a mounting bar, according to certain inventive techniques.

FIG. 6 illustrates another alternative perspective view of a nested cartridge system, according to certain inventive techniques.

FIG. 7 illustrates a perspective view of another nested cartridge system, according to certain inventive techniques.

FIG. 8 illustrates a perspective view of the nested cartridge system illustrated in FIG. 7, according to certain inventive techniques.

FIG. 9 illustrates a perspective view of the nested cartridge system illustrated in FIG. 7 and a mounting bar, according to certain inventive techniques.

FIG. 10 illustrates a perspective view of another single cartridge assembly with a measuring tool, according to certain inventive techniques.

FIGS. 11 and 12 illustrate perspective views of measuring tool for the cartridges illustrated in FIGS. 3 and/or 10, according to certain inventive techniques.

FIGS. 13A and 13B illustrate perspective views of a single cartridge assembly, according to certain inventive techniques.

FIGS. 14A and 14B illustrate perspective views of the single cartridge assembly of FIGS. 13A and 13B with a lifted lid, according to certain inventive techniques.

FIGS. 15A and 15B illustrate perspective views of a cross-section of the single cartridge assembly of FIGS. 13A and 13B, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearances shown in the drawings are one of many ornamental appearances that can be employed to achieve the stated functions of the system.

### DETAILED DESCRIPTION

In disclosed examples, a nested cartridge system is configured to store and/or dispense particulate food products, such as spices and herbs. The system houses one or more cartridge assemblies, which provide a secure and sanitary container for the food product. When stored in the nested container, the cartridge assemblies are preferably oriented at an angle, and organized to be easily identified and grasped. The cartridge assembly includes a compatible measuring tool, which provides multiple measurement units for convenience.

Conventional storage systems cannot be moved from one location to another, as the mounting and/or stabilization means are made for a specific storage position. For at least this reason, it is difficult to identify and access the contents of such systems. As a result, a user may inadvertently select the wrong product, and/or run out of a particular item without being able to identify the particular empty container.

Furthermore, conventional storage systems for frequently used products are disposable, which does environmental damage when replaced. If an untrained user does attempt to refill a container, it may be with the wrong contents, leading to mislabeling and frustration or, worse, feeding someone with an allergy a potentially harmful ingredient.

In order to dispense the contents properly, conventional systems employ generic and/or multiple measurement tools. This creates multiple various items to be cleaned, and can result in erroneous measurements when the proper tool is not available.

In an effort to address these issues and more, the disclosed nested cartridge system provides a useful storage and dispensing system. The various cartridges are arranged to be conveniently viewed and/or grasped by a user. Each cartridge is sealed to ensure freshness and product contents. Refilling the system is limited to a single component (i.e. a body) of a cartridge assembly, thereby limiting the environmental impact over continued use of the system. Moreover, the system preferably includes a measurement tool compatible with each cartridge assembly, which provides reliable measurement. The features and advantages of the disclosed system are described more fully with respect to the various figures.

In disclosed examples, a nested cartridge system is configured to store and dispense particulate food products. The system includes one or more cartridge assemblies to provide a secure and sanitary container for the food product, wherein the system includes a compatible measuring tool comprising multiple measurement units, one or more interfaces of individual components of the cartridge system comprising an ultrasonic weld. A nested container to store the cartridge assemblies at an angle relative to a mounting surface.

In some examples, the adjustable measuring tool further comprises a sleeve and a cap, the cap being removably secured to the body. In examples, the sleeve is configured to move relative to the cartridge assembly. In some examples, one or more of the cartridge assembly, the nested container, or the measuring tool is formed in an injection molding process.

In some examples, the body comprises a first material and the nested container comprises a second material. In examples, the first material comprises a polyethylene material or a polypropylene material. In examples, the second material comprises a thermoplastic elastomer material.

In some examples, one or more of the cartridge assembly, the nested container, or the measuring tool is formed of wood, metal, or a fibrous material. In examples, the metal is one of stainless steel, aluminum, steel, or metal alloys. In examples, the cartridge assembly, the nested container, and the measuring tool are formed of the same material.

In disclosed examples, a cartridge assembly is configured to store and dispense particulate food products. The cartridge assembly includes one or more lateral surfaces, a dispensing surface on a first end of the one or more lateral surfaces, and a base on a second end of the one or more lateral surfaces opposite the first end, wherein one or more of the dispensing surface or the base is secured to the one or more lateral surfaces of the cartridge system by an ultrasonic weld.

In some examples, the cartridge assembly is further configured to receive a compatible measuring tool comprising multiple measurement units, wherein the adjustable measuring tool further comprises a sleeve and a cap. In examples, the cartridge assembly further includes one or more tabs protruding from the one or more lateral surfaces, the one or more tabs configured to mate with one or more tabs of the sleeve or the cap to removably secure the sleeve or the cap to the body. In examples, the sleeve is configured to move relative to the cartridge assembly. In examples, the compatible measuring tool comprises a substantially transparent material.

In some examples, the cartridge assembly further includes a lid integrated with the dispensing surface of the cartridge assembly. In examples, the lid is configured to open about a hinge to access an interior volume of the cartridge assembly. In examples, the dispensing surface comprises one or more holes to access an interior volume.

In some examples, the cartridge assembly is further configured to fit into a respective dock of a nested container such that the cartridge assembly is arranged at an angle relative to a mounting surface of the nested container.

In examples, the cartridge assembly includes a first material and the nested container comprises a second material, the first or second material comprising one or more of a polyethylene material, a polypropylene material, a thermoplastic elastomer material, wood, metal, a fibrous material, stainless steel, aluminum, steel, or metal alloys.

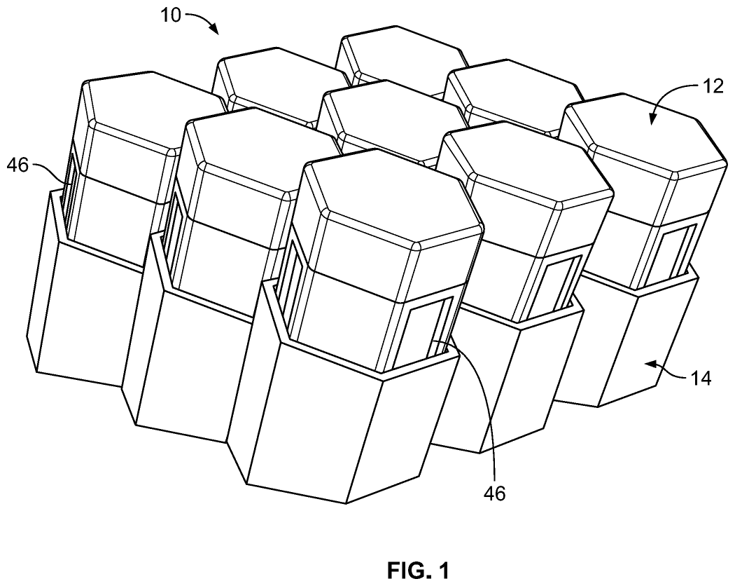

One embodiment of the present technology, as illustrated in FIG. 1, is a nested cartridge system 10 that includes a nested container 14 configured to hold a plurality of cartridge assemblies 12. The nested container 14 is formed with a plurality of docks or cells to accept cartridge assemblies 12 of various shapes and/or sizes, arranged in a manner to allow space between cartridge assemblies 12 to ensure each can be easily grasped and removed from the nested container 14, and replaced.

In the example shown in FIG. 1, the nested container 14 is configured to hold nine (9) cartridge assemblies 12 in a generally rectangular 3×3 matrix. In other examples, the nested container 14 can accept any number of cartridge assemblies 12, and may be arranged in any shape (e.g., generally circular, triangular, annular, linear, etc.).

In some examples, each cartridge assembly 12 consists of multiple components that together are configured to contain a media, such as particulate matter (e.g., a powder, ground spice, etc.). Although illustrated as having a similar size and shape, different cartridge assemblies may have a variety of distinguishing characteristics. For example, color, shape, size, markings, etc., can be employed to aid in identification and/or placement of a particular cartridge and/or its contents. The dock can be similarly modified to physically accept and/or visually pair with the various cartridge assemblies to facilitate insertion and/or identification of unique cartridge assemblies and their contents.

In the example of FIG. 1, the docks are tilted relative to a mounting surface. This orientation provides for easy viewing of each cartridge assembly 12, such as product information and/or labelling. Advantageously, the tilted arrangement holds the cartridge assemblies 12 in an upright orientation, thereby preventing the cartridge assembly 12 and/or the contents from falling out, such as when the system 10 is mounted to a vertical surface (e.g., a wall, door, cabinet, etc.). Although illustrated being oriented in a common direction, the nested container 14 can arrange the various docks over a variety of angles.

The system 10 can be made of a variety of materials. For example, one or more components of the system (e.g., the nested container 14, the cartridge assembly 12 or any portion thereof) can be made of a common material (such as thermoplastic). In some examples, one or more of the system 10 components are formed with a variety of materials, to include wood, metal (e.g., stainless steel, aluminum, steel, or metal alloys), a fibrous material (e.g., textiles, carbon or polymeric woven material, etc.), or other materials suitable for a manufacturing process and/or storage and display.

The system 10 is designed to be conveniently located on a counter, within a drawer or cabinet, or mounted to a vertical surface. As such, the system 10 is preferably sized to require a modest amount of space in a kitchen, for instance, and be easily moved by hand. For example, the nested container 14 can have base dimensions of approximately 7 inches by 7 inches or less. In a preferred embodiment, the nested container 14 has base dimensions of approximately 6½ inches by 5¾ inches. The nested container 14 can have a height of approximately 2 inches at the height of the tilted dock, or approximately 1½ inches in a preferred embodiment. In some examples, the cartridge assembly 12 has a height of approximately 3 inches from a surface 40 to base 38. The cartridge assembly 12 can have a diameter of approximately 2 inches or less, and preferably approximately 1½ inches. In a hexagonal configuration, as shown, each side may have a length of approximately 1 inch or less. When the cartridge assembly 12 is docked in the nested container 14, the height of the combined system can measure approximately 3 inches or less, and preferably approximately 2 ½ inches.

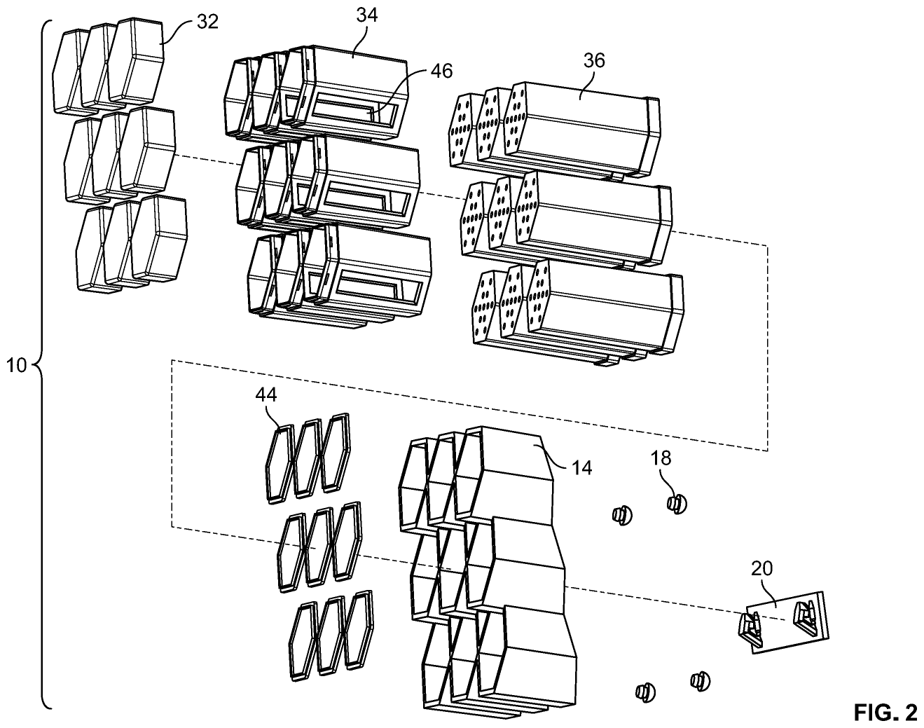

FIG. 2 illustrates an exploded perspective view of a nested cartridge system, such as the nested cartridge system 10 shown in FIG. 1. As shown, a cap 32 connects with a cartridge body 36. A base 38 is secured to the body 36 to prevent contents from spilling. The cartridge assembly 12 can be dimensioned to fit into a respective dock of the nested container 14.

One or more bumpers 18 can be attached to a mounting surface of the nested container 14, such as to provide a non-skid contact point between the system 10 and a mounting location (e.g., a countertop, a wall, a cabinet door, etc.). Each bumper 18 can be press-fit into a predetermined pattern formed within the nested container 14, and/or be secured by an adhesive or other fastener. Bumpers 18 (e.g., pads, grommets, “feet,” mounts, tips, etc.) can be made of a material that provides a deformable contact between the system and a mounting location, such as rubber, a polymer, cork, fabric, wood, or any other suitable material.

A mounting bar or plate 20 can be used to attach the nested container 14 to a surface (e.g., a wall, a cabinet, a door, etc.). The mounting bar 20 can be secured to the surface with a variety of fasteners, such as an adhesive, screw, pressure sensitive tape, etc. The mounting bar 20 can be formed with hooks molded as an integral part of the bar, the hooks being arranged to fit into one or more openings on the mounting surface of the nested container 14, thereby securing the system on such a surface. Advantageously, the system 10 can be removed for cleaning or relocating the containers, and then returned without the need for tools. Additionally or alternatively, the system 10 can be mounted directly to a surface by a fastener (e.g., adhesive, screw, etc.).

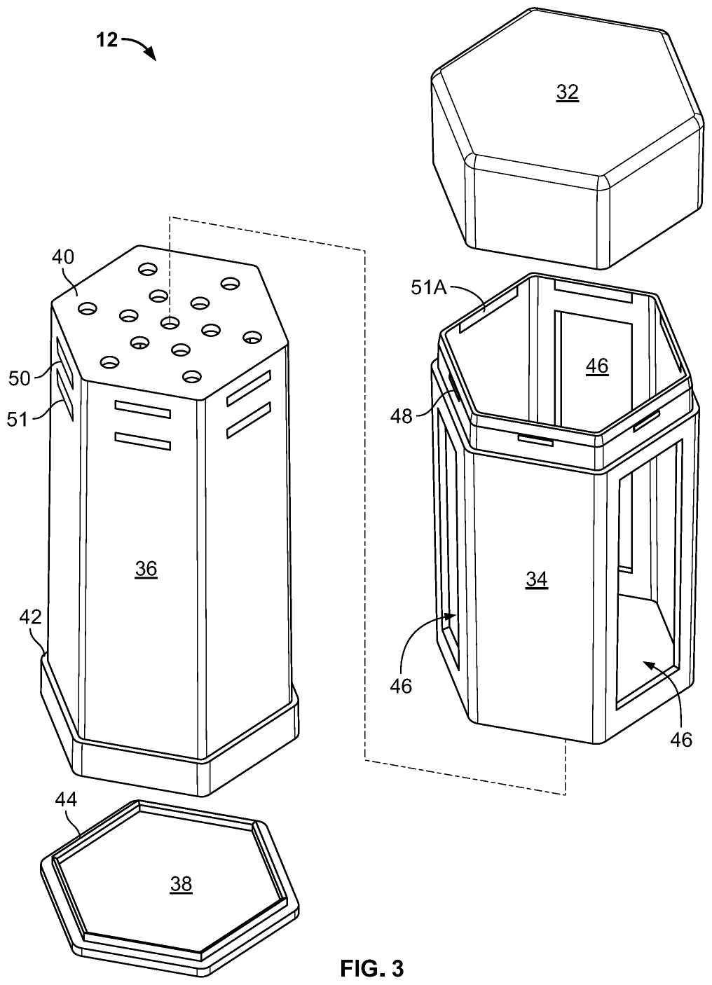

FIG. 3 illustrates a detailed exploded view of a single cartridge assembly 12. As shown, cap 32 is configured to connect with body 36, which is formed with one or more tabs 50 to create a snapably removable seal between the cap 32 and body 36. A second set of tabs 51 are located on the body 36 to mate with one or more tabs 51A of the sleeve 34, such that when the sleeve 34 is slid over the body 36, pressure between tabs 51 and 51A hold the sleeve 34 in place.

The sleeve 34 can be formed with one or more voids 46 in order to view the body 36 when the assembly 12 is completed. For example, the body 36 may have identifying characteristics that represent the contents (e.g., a label, color, markings, texture, etc.) that are revealed through the void 46. The body 36 can be formed of a transparent material such that the contents are visible through the void 46. For example, one or more markings can be used to represent an amount of product within the cartridge body 36, such as a line below which the product should be refilled.

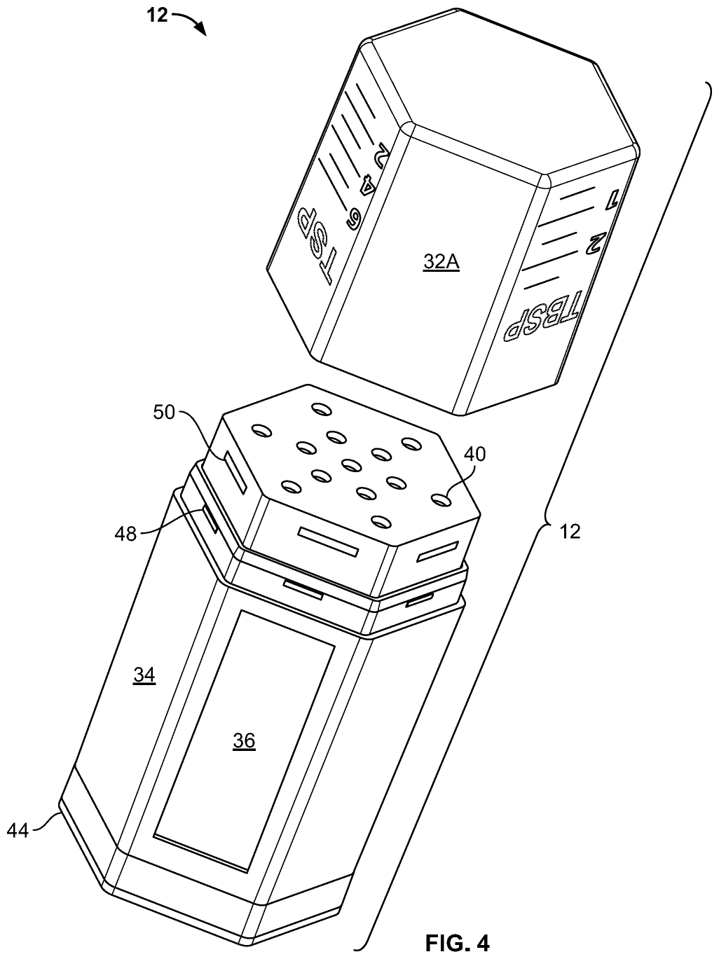

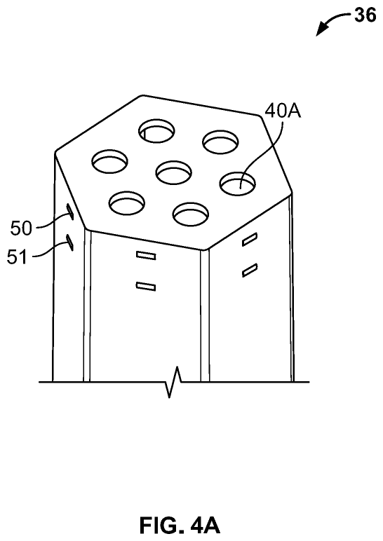

The body 36 includes a dispensing surface 40 that, when assembled, the cap 32 protects the contents exposed by one or more holes on the dispensing surface 40 when stored in the nested container 14, the holes being configured to access an interior volume of the respective cartridge. Further, the cap 32 can be removed, such that the cartridge assembly 12 can be inverted to dispense the contents into a measuring tool 32A, as shown in greater detail in FIG. 4.

Base 38 is secured to the body 36 to prevent contents from spilling, and the cartridge assembly 12 can be dimensioned to fit into a respective dock of the nested container 14. In the example of FIG. 3, the base 38 has a raised wall 44 formed to fit within an interior of a border 42 at an end of the body 36. For instance, the body 36 can be formed as a single component by one or more forming techniques, such as injection molding, additive manufacturing, or other suitable process. Once the body 36 is filled, wall 44 of the base 38 can be fitted within the border 42 to make a secure enclosure. Once the base 38 is in place, the components are bonded such that removal of the base 38 from the body 36 is prevented.

Bonding of the base 38 to the body 36 can be performed in a variety of ways. In an embodiment, an ultrasonic welding method is performed to bond the base 38 and body 36. For instance, two parts made of compatible materials can be bonded using high frequency ultrasonic vibrations, thereby generating a weld at the interface. The ultrasonic energy melts the point contact between the parts, creating a joint. This process is a good automated alternative to glue, screws or snap-fit designs.

In some examples, the cartridge assembly 12 is used in storing and dispensing food products. Ultrasonic welding is uniquely beneficial in food packaging as the method is fast, sanitary and produces a hermetic seal between components. Ultrasonic welding works well with a variety of materials suitable for forming components of the nested container system, such as plastics (e.g., polymers, such as polypropylene and polyethylene, acrylics, thermoplastics, etc.), but can also be used with metals, carbon based materials, and others.

Particularly advantageous in bonding plastics, ultrasonic welding can be performed quickly, cures in seconds and results in a strong bond that is gas and water tight. Thus, the body 36 is filled from the bottom and the base 38 is permanently attached via sonic welding or other means of adhesion. This preserves product freshness, prevents tampering, and precludes refilling of the container by the consumer. Other bonding methods include fasteners such as screws, adhesives, threads, solder, as several non-limiting examples.

FIG. 4 illustrates a cartridge assembly 12 and a measuring tool 32A, which can include markings that represent one or more volume measurements. In the example of FIG. 4, tablespoon and teaspoon are shown. Further, one or more components of the cartridge assembly 12 can be formed from transparent and/or opaque materials (e.g., cartridge body 36, sleeve 34, base 38, measurement tool 32A, and cap 32). For example, a transparent container allows visibility of the contents. Additionally or alternatively, tinting of the material can correspond to a particular product (e.g., a white tint can correspond to salt; black to pepper; red to paprika; etc.).

Once filled, sealed, and labeled, cartridge assemblies 12 may be sold as individual units or in multiples, either as a customizable kit or part of a set (e.g., the nested container 14 filled to capacity with selected spices). In some examples, a filled and sealed body 36 and base 38 can be sold separately. Once the contents of a cartridge assembly 12 have been used, additional cartridges can be sold as refills. Advantageously, the use of an ultrasonic bond ensures that the cartridge cannot be tampered with.

In a representative filling process, a body 36 will be filled with a selected product, and the base 38 sealed to the body 36 as disclosed herein. A label is applied to the filled and sealed body 36, to which a sleeve 34 is slid down over the label. Thus, the sleeve 34 and cap 32 are reusable, as they may be color coded and/or configured for placement in the nested container 14, and only the filled and sealed body 36 and base 38 are replaced. As disclosed herein, a void is provided in the sleeve 34, such that the label affixed to the base 36 and/or the contents are visible even when fully assembled.

FIG. 4A illustrates a perspective view of the cartridge body 36. As shown, the dispensing surface has a larger gauge opening 40A in comparison to the openings shown in FIG. 4. For instance, openings of various sizes, shapes and/or configurations can be selected for dispensing different product contents (e.g., fine versus coarse particles).

When prepared for distribution, dispensing openings are covered with a removable seal prior to filling. This is done to enclose the container and to ensure product freshness and/or tamper prevention. Seals may be applied via heat, induction, pressure sensitive, bonding, or other suitable sealing processes. For example, a heat sensitive material can be placed on the surface 40, and heat is applied around outer edges of the surface at a manufacturing stage to create a water and gas-tight seal. In some examples, a buffer region between the edge of the surface 40 and the one or more holes (e.g., ⅛ of an inch) is maintained such to provide sufficient surface for a bond to form between the seal and the base 38.

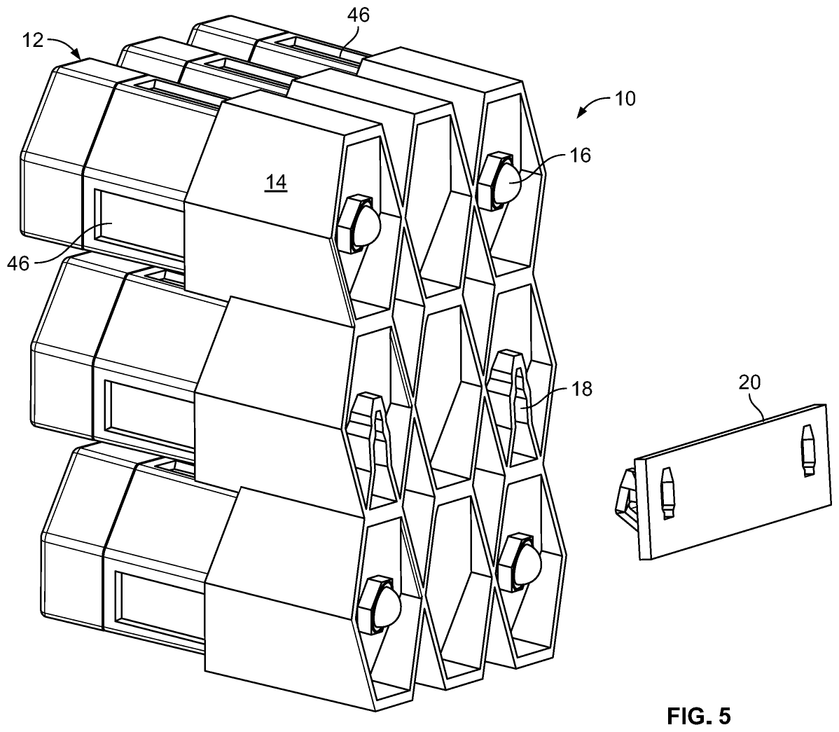

FIG. 5 illustrates a rear facing perspective view of the nested cartridge system 10 with a mounting bar 20. In this example, four (4) bumpers 18 are attached at the rear mounting surface of the nest 14 to serve as a buffer between the system 10 and a wall, countertop, cabinet, etc. The mounting bar 20 can be attached to the location for mounting, and the system 10 can be secured to it, by aligning hooks extending from the mounting bar 20 with mounting aperture 22. Although the rear mounting surface is illustrated as tilted, with indented spaces to serve as a backstop to a cartridge assembly 12 inserted into a dock, the mounting surface can be flat and/or the spaces may be filled in. Additionally or alternatively, bumpers 18 may be located on an interior or exterior edge of the nest 14, and/or the mounting bar 20 may be fitted with a material to provide a buffer between the mounting location and the nest 14.

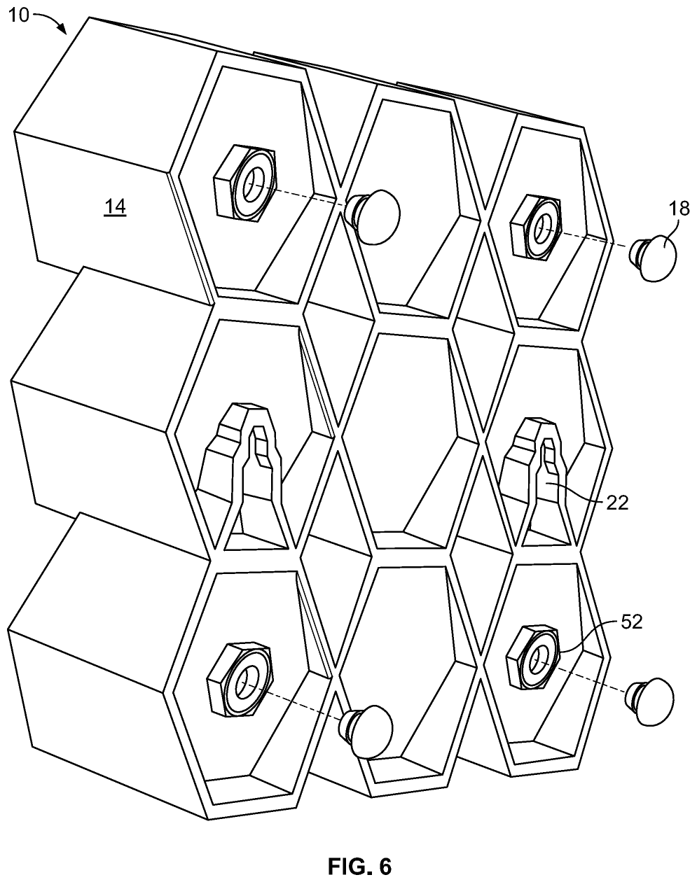

FIG. 6 illustrates another rear facing perspective view of the nested cartridge system 10. As shown, bumpers 18 are removed, aligned with mounting aperture 52 which are configured to removably accept the bumpers 18 (e.g., a pressure sensitive, self-adhesive bumper, a rubber bumper, etc.). In some examples, a screw or other fastener can extend through the mounting aperture 52 to secure the nesting container 14 to the mounting surface.

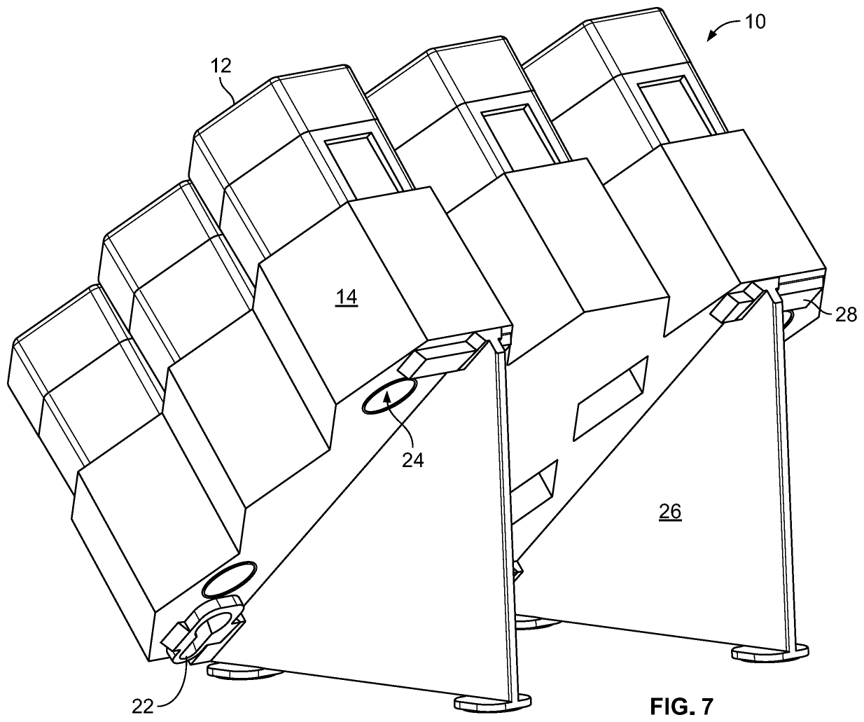

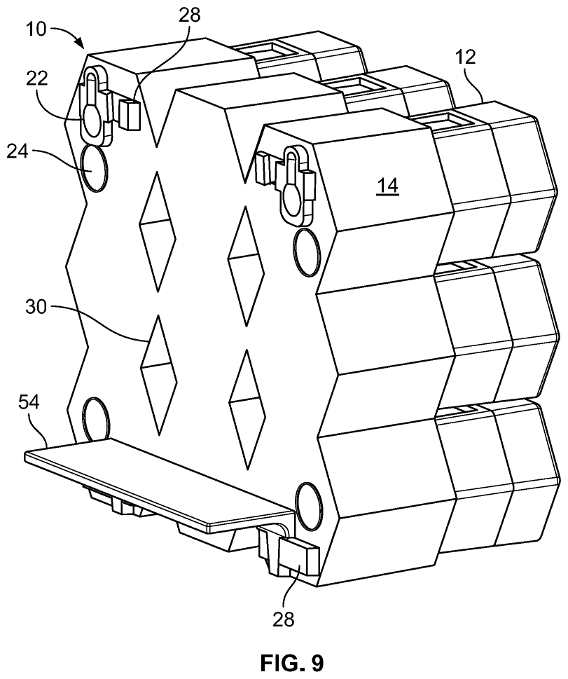

FIG. 7 illustrates another nested cartridge system 10, such that the cartridge assemblies 12 are oriented perpendicularly to the rear mounting surface of the nesting container 14. Thus, as shown, the system is fitted with mounting wedges 26 to provide an angled orientation for the cartridge assemblies 12. The wedges 26 position the system 10 for better viewing of the products when on a flat surface, such as a countertop. The wedges 26 are configured for insertion into receivers 28, molded or otherwise formed on the rear surface of the nested container 14. In some examples, receivers 28 can be used with a mounting bar (see, e.g., FIG. 9).

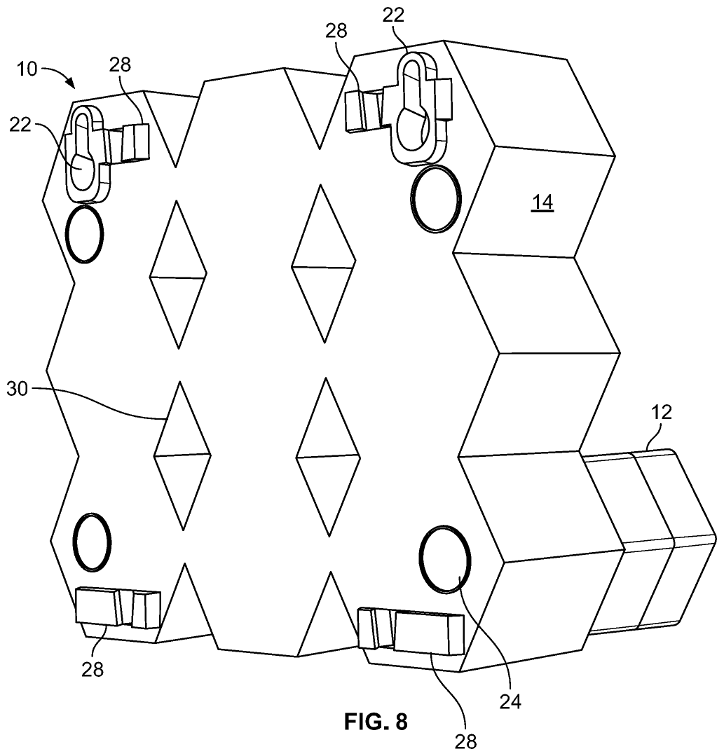

As is further illustrated in FIG. 8, bumper attachment 24, can accept a variety of bumpers, such as a self-adhesive bumper or a push in bumper (e.g., feet, grommet, etc.) for wall, counter, and/or door mounting. For example, bumper attachment 24 can accept a bumper similar to bumper 18 in a manner similar to mounting aperture 52. Further, the rear mounting surface is flat, versus the tilted arrangement shown in FIGS. 1, 2, 5 and 6.

FIG. 9 illustrates a perspective view of the nested cartridge system illustrated in FIG. 7 and a mounting bar 54. As shown, when cartridge assemblies 12 are in place, the mounting bar 54 serves to angle the assemblies relative to the location for mounting.

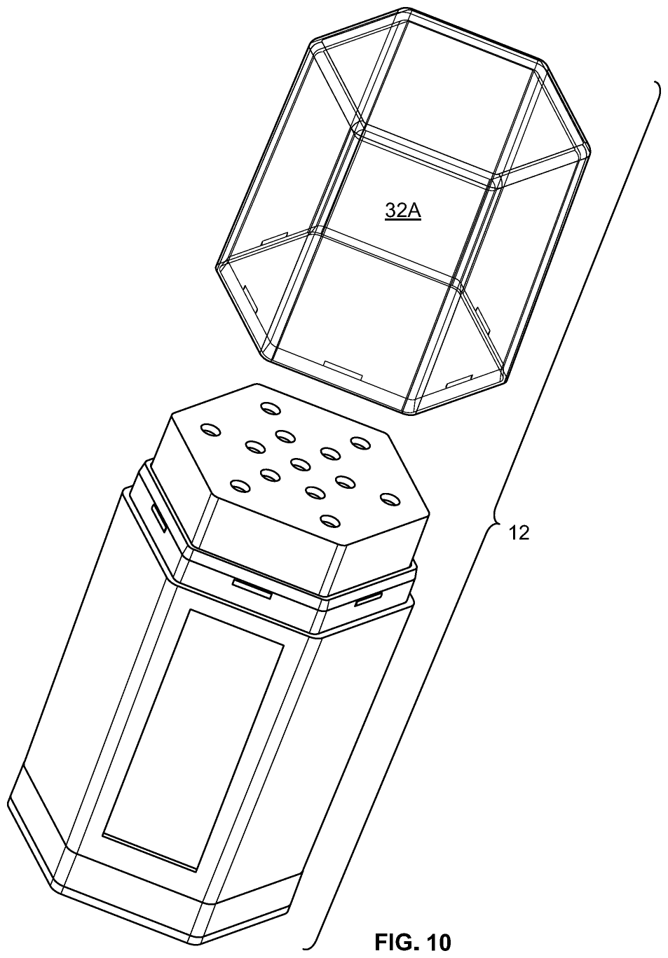

FIG. 10 illustrates a perspective view of another single cartridge, similar to the view shown in FIG. 4. In the example of FIG. 10, the measuring tool 32A is transparent, allowing one to view the container components and/or contents therein. Although disclosed as transparent, the measuring tool 32A may have varying levels of opacity and/or be colored differently. Similarly, one or more components of the nested container system 10 may also have varying degrees of transparency or opacity, different colors, made of one or more various materials, and/or other structural or ornamental characteristics.

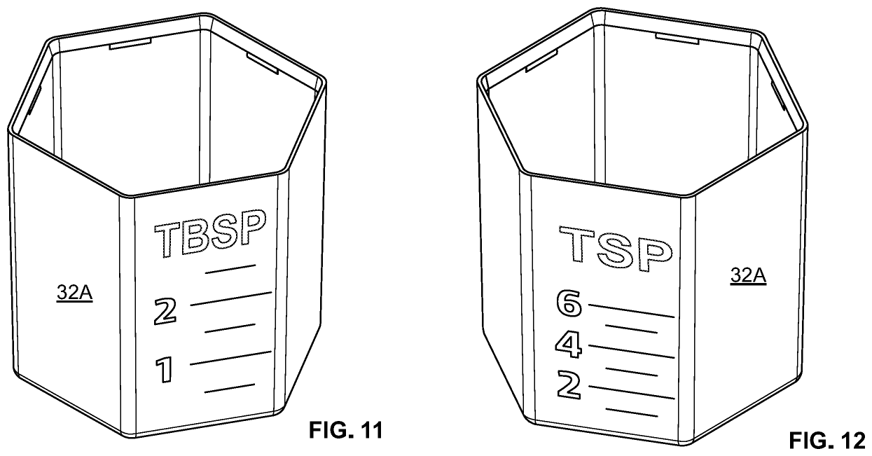

FIGS. 11 and 12 show different views of measuring tool 32A. For example, a clear measuring tool 32A is configured to snap onto the body 36 and/or the sleeve 34. When inverted to dispense the contents, the markings provide the ability to measure the contents in teaspoons, tablespoons and/or another suitable measurement system.

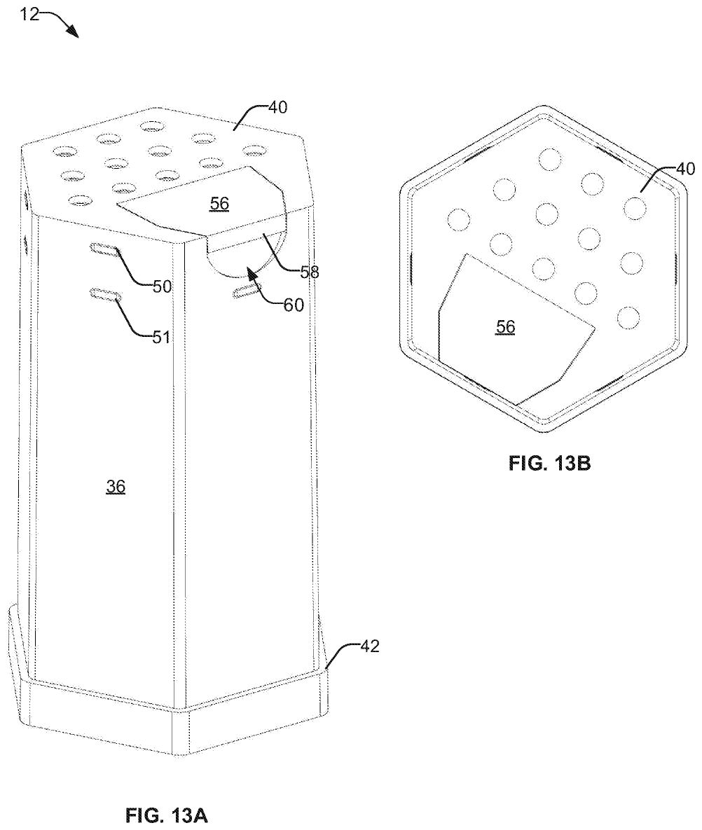

FIG. 13A illustrates a detailed perspective view of a single cartridge assembly 12 similar to the cartridge assembly 12 shown in FIG. 3. Additionally, as shown in FIG. 13A, the cartridge assembly 12 contains a lid 56, which may be opened to access an interior volume of the cartridge assembly 12 and the contents therein. In some examples, the lid 56 may be opened by removing the lid 56, by use of a hinge, or other suitable action or mechanism. As shown, a depression 60 may be formed in a wall below a lip 58 to facilitate lifting the lid 56 (e.g., with a finger, a tool, etc.). FIG. 13B illustrates a top view of the cartridge assembly 12, with the lid 56 in a closed configuration.

Similar to the assembly 12 of FIG. 3, the assembly 12 of FIG. 13A is configured to fit the cap(s) 32/32A with body 36, which is snapably removable from one or more tabs 50 to create a seal between the cap(s) 32/32A and body 36. A second set of tabs 51 are located on the body 36 to mate with one or more tabs 51A of the sleeve 34.

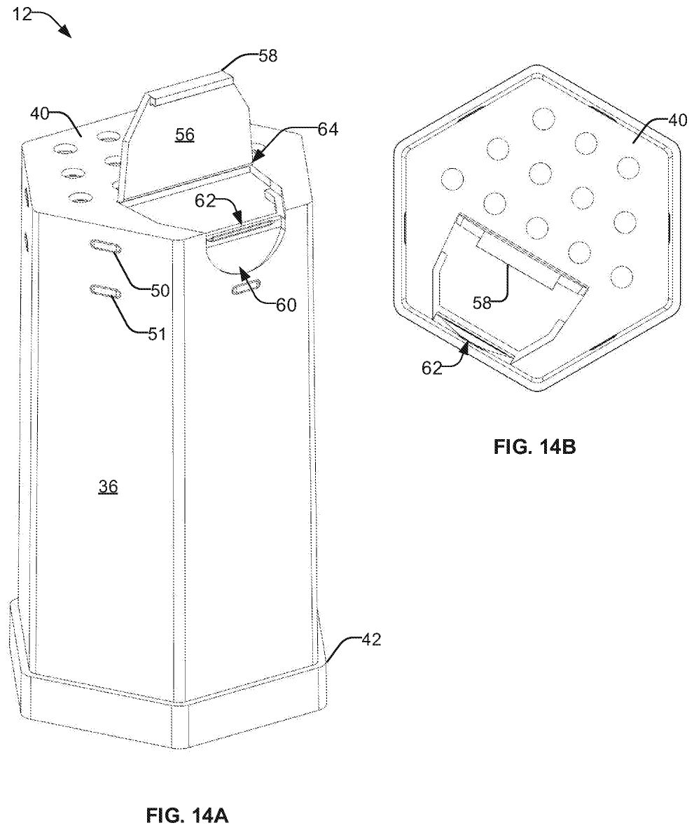

FIGS. 14A and 14B illustrate perspective views of the cartridge assembly 12 of FIGS. 13A and 13B with the lid 56 in an open configuration. In the illustrated example, the lid 56 rotates about a hinge 64, opened at an approximate 90-degree position. In some examples, the lid 56 can be opened to rest against the surface 40, or be limited to a smaller opening between the closed configuration and resting against the surface 40. In some examples, the hinge 64 is molded with the assembly, such that a thinner amount of material between the surface 40 and lid 56 serves as hinge 64. In other examples, the hinge 64 is a separate structure, secured to both the surface 40 and the lid 56. A lip 62 is provided at the top of the depression 60 to secure the lid 56 when in a closed configuration.

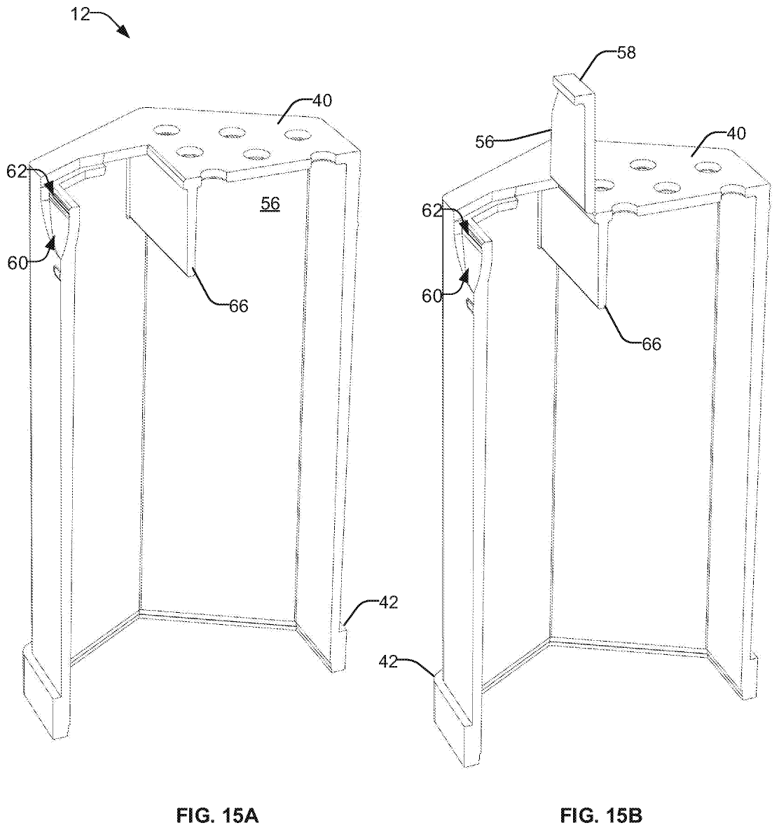

FIGS. 15A and 15B illustrate perspective views of a cross-section of the single cartridge assembly 12 of FIGS. 13A and 13B. In the example of FIG. 15A, the lid 56 has been removed. In the example of FIG. 15B, the lid 56 is shown in an open configuration at an approximate 90-degree position. As shown, a partition 66 may be employed between the lid 56 and the holes on the surface 40. The partition 66 may extend the width or length of the cartridge 36, or may extend to only a portion of the width or length. In some examples, the partition separates two compartments, which may be used to store different materials.

The embodiments disclosed herein are not limited to specific polymers or materials discussed with respect to those embodiments. Any number of different kinds of polymers having different properties can be used with the embodiments disclosed herein.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A nested cartridge system is configured to store and dispense particulate food products, the system comprising:
one or more cartridge assemblies to provide a secure and sanitary container for the food product, wherein the system includes a compatible measuring tool comprising multiple measurement units, one or more interfaces of individual components of the cartridge system comprising an ultrasonic weld; and
a nested container to store the cartridge assemblies at an angle relative to a mounting surface.

2. The system of claim 1, wherein the adjustable measuring tool further comprises a sleeve and a cap, the cap being removably secured to the body.

3. The system of claim 2, wherein the sleeve is configured to move relative to the cartridge assembly.

4. The system of claim 1, wherein one or more of the cartridge assembly, the nested container, or the measuring tool is formed in an injection molding process.

5. The system of claim 1, wherein the body comprises a first material and the nested container comprises a second material.

6. The system of claim 2, wherein the first material comprises a polyethylene material or a polypropylene material.

7. The system of claim 2, wherein the second material comprises a thermoplastic elastomer material.

8. The system of claim 1, wherein one or more of the cartridge assembly, the nested container, or the measuring tool is formed of wood, metal, or a fibrous material.

9. The system of claim 8, wherein the metal is one of stainless steel, aluminum, steel, or metal alloys.

10. The system of claim 8, wherein the cartridge assembly, the nested container, and the measuring tool are formed of the same material.

11. A cartridge assembly configured to store and dispense particulate food products, the cartridge assembly comprising:
one or more lateral surfaces;
a dispensing surface on a first end of the one or more lateral surfaces; and
a base on a second end of the one or more lateral surfaces opposite the first end, wherein one or more of the dispensing surface or the base is secured to the one or more lateral surfaces of the cartridge system by an ultrasonic weld.

12. The cartridge assembly of claim 11, further configured to receive a compatible measuring tool comprising multiple measurement units, wherein the adjustable measuring tool further comprises a sleeve and a cap.

13. The cartridge assembly of claim 12, further comprising one or more tabs protruding from the one or more lateral surfaces, the one or more tabs configured to mate with one or more tabs of the sleeve or the cap to removably secure the sleeve or the cap to the body.

14. The cartridge assembly of claim 12, wherein the sleeve is configured to move relative to the cartridge assembly.

15. The cartridge assembly of claim 12, wherein the compatible measuring tool comprises a substantially transparent material.

16. The cartridge assembly of claim 11, further comprising a lid integrated with the dispensing surface of the cartridge assembly.

17. The cartridge assembly of claim 16, wherein the lid is configured to open about a hinge to access an interior volume of the cartridge assembly.

18. The cartridge assembly of claim 16, wherein the dispensing surface comprises one or more holes to access an interior volume.

19. The cartridge assembly of claim 11, further configured to fit into a respective dock of a nested container such that the cartridge assembly is arranged at an angle relative to a mounting surface of the nested container.

20. The cartridge assembly of claim 19, wherein the cartridge assembly comprises a first material and the nested container comprises a second material, the first or second material comprising one or more of a polyethylene material, a polypropylene material, a thermoplastic elastomer material, wood, metal, a fibrous material, stainless steel, aluminum, steel, or metal alloys.
